(19) United States
(12) Patent Application Publication
(10) Pub. No.: US 2015/0332291 A1
(43) Pub. Date: Nov. 19, 2015

(54) SYSTEMS AND METHODS FOR IDENTIFYING CUSTOMERS USING PAYMENTS DATA

(71) Applicant: Swipely, Inc., Providence, RI (US)

(72) Inventors: Matthew Gillooly, Providence, RI (US); Dan Hodge, Providence, RI (US); Anthony Accardi, Providence, RI (US); Angus M. Davis, Providence, RI (US)

(21) Appl. No.: 14/715,368

(22) Filed: May 18, 2015

Related U.S. Application Data
(60) Provisional application No. 62/000,076, filed on May 19, 2014.

(51) Int. Cl. G06Q 30/02; G06Q 20/20

(52) U.S. Cl. CPC G06Q 30/0201; G06Q 20/20

(57) ABSTRACT

Systems and methods may identify customers based on payment and point-of-sale (POS) data collected from a merchant POS system. In one aspect, the systems and methods receive the POS data at a secure server. Customer identities may be determined based on a randomly-generated token associated with a payment identifier. Customer payment data and third-party reservation data may be matched with the POS data and the customer identities at the secure server based on ticket information to generate consumer metrics. In some embodiments, the systems and methods generate the consumer metrics for display on a client electronic device for a merchant/retailer.

### RELATED APPLICATIONS

This application claims priority to U.S. Provisional Application No. 62/000,076, entitled SYSTEMS AND METHODS FOR IDENTIFYING CUSTOMERS USING PAYMENTS DATA, filed May 19, 2014 and naming Matthew Gillooly, Dan Hodge, Anthony Accardi, and Angus M. Davis as inventors, the contents of which are incorporated by reference.

### TECHNICAL FIELD

The systems and methods described herein relate to systems for matching data from one data source with data in a different data source to add a data field from matched data sets.

### BACKGROUND

Today, customers in many parts of the world have grown accustomed to using electronic payment to handle transactions. Some examples of electronic payment methods include debit cards, credit cards, and direct (store) credits. In the meantime, point-of-sale or point-of-service (POS) systems have been developed and widely adopted by the retail industry to assist merchants and customers with transactions involving electronic payment. Some advanced POS systems may integrate additional functionalities, such as inventory management and warehousing to help the retail merchants better understand and manage their business. For example, a POS system at a local convenience store may accept a credit card payment from a customer in exchange for goods or services rendered (e.g., for five cases of printing paper purchased). If the store's POS system supports the additional functionality of inventory management, the POS system may also automatically deduct the number of cases of printing paper from the inventory of the store by five.

However, such additional functionalities of POS system are severely limited by the need for cross-platform integration between the POS system and other stand-alone applications. Small businesses typically need to employ third-party solutions to analyze business transaction data in order to deduce any useful sales and marketing insights. In the above example, the local convenience store would have to integrate the POS system with independent accounting applications, financial applications, customer relationship management (CRM) applications, etc. in order to translate sales data into meaningful business performance measurements.

In particular, a major limitation of existing POS systems is that they cannot effectively identify new and returning customers or track customer visits over time. A customer could visit the same restaurant five times in the same week, each time ordering the same menu item. However, barring any careful waiter who takes notice, the restaurant owner might not be able to recognize the identity of the loyal customer, much less to gain any insight about the particular menu item that kept the customer's loyalty or any developing relationship between the customer and any waiter. Third-party solutions that provide analytics for business transactions over time are usually unable to trace the behavior of individual customers across multiple visits because of their inability to identify customers.

As such, existing businesses have to rely on rewards incentives to identify customers. For instance, many retailers have implemented rewards programs that offer membership discounts to customers who provide their identity using a loyalty card. A customer may scan the loyalty card at check-out, thereby linking the customer's identity to the items purchased during a particular transaction. Some third-party solution-providers, such as OpenTable®, take a similar approach by requiring users to establish online identities, which can be integrated with a restaurant owner's existing reservation system. However, these solutions cannot capture the activities of those customers who do not sign up for loyalty cards, or those without an online identity.

Hence, there exists a need to help merchants to identify customers seamlessly during business transactions, without any third-party add-ons or any additional steps necessary by the customers.

### SUMMARY OF THE INVENTION

The systems and methods described herein include, among other things, systems and methods for identifying customers through their payment information and associating the customers with their ongoing activities at various merchants. Insights may be gained as to what merchants can do to improve the experiences of their customers. While some existing solutions may analyze payment, ticket, menu, labor, or reservation data in isolation, the present systems and methods stitch the various data sources together in a way that individual behavior can be reliably tracked over time. Subsequently, the merchant may discover insights about how various factors under the merchant's control may impact customer retention.

A number of different types of systems and methods will be described with reference to certain figures. However, it is to be understood that these figures are only for illustrative purposes and that other systems and methods may be employed without departing from the scope of the invention.

In one particular system and method described herein, a customer-identifying system includes a merchant POS terminal that can interface with electronic payment mechanisms. The merchant POS terminal may additionally store POS data and run one or more extraction software for retrieving and encrypting the POS data. The merchant software may run on the merchant POS terminal or on a back-office computer connected to the terminal. In an implementation, the merchant POS terminal may be coupled to a payment processor, such as a networked server by First Data®, which generates payment data by interfacing with the payment mechanism of the merchant POS terminal. The payment processor and the extraction software running on the merchant POS terminal may make available the payment data and the POS data, respectively, to a secure server, such that the secure server may poll the payment data and the POS data on a periodic basis. In some embodiments, instead of a polling mechanism, the POS data and the payment data may be streamed in real-time or near real-time from the merchant POS terminal to the secure server. Alternatively, a notification-based system may be implemented, in which the POS data and the payment data are processed and forwarded to the secure server as soon as they are received by the merchant POS system. In some implementations, additional data, such as reservation data, may be polled from third-party services such as online reservation platforms. Alternatively, instead of a polling mechanism, the additional data may be streamed in real-time or near real-time from the online reservation platforms, or be forwarded from the online reservation platforms in a notification-based system.

In some embodiments described herein, one or more services may be provided at the secure server that maps and matches the received POS data and payment data into data clusters. Correlations may be drawn based on common parameters such as names, transaction dates and times, and transaction identifiers. The identity of the customers associated with the POS data and the payment data may be generated based on the data clusters. The customers' identities, payment data, POS data, and any other information may be stored in a data storage of the secure server and be used to compute consumer metrics associated with the identified customers.

In an implementation, the consumer metrics may be dynamically compiled into reports based on the need of the user (e.g., a merchant/retailer), which may be displayed on the user's electronic device.

The methods described herein can be a computer process of any type including a computer program, an application (i.e., app), an application as a service, or any suitable computer program.

### BRIEF DESCRIPTION OF THE DRAWINGS

The systems and methods described herein are set forth in the appended claims. However, for purpose of explanation, several embodiments are set forth in the following figures.

FIG. 1 is an exemplary diagram of data flow and key processing algorithms as used in accordance with some embodiments.

FIG. 2A is an exemplary secure cloud service implemented using AWS.

FIG. 2B shows one process for matching parameters between tables to link a transaction in one table to an identity parameter in another table.

FIG. 3 is an exemplary web report of customer retention rate for menu items as displayed on user devices in accordance with some embodiments.

FIG. 4 is an exemplary web page of creating a new customer list as accessible on user devices in accordance with some embodiments.

FIG. 5 is an exemplary web report of customer list as displayed on user devices in accordance with some embodiments.

FIG. 6 is an exemplary web report of sales data as displayed on user devices in accordance with some embodiments.

FIG. 7 is an exemplary web report of new vs. repeat sales as displayed on user devices in accordance with some embodiments.

FIG. 8 is an exemplary web report of customer relationship management (CRM) scorecard as displayed on user devices in accordance with some embodiments.

FIG. 9 is an exemplary web report of recent customer activity as displayed on user devices in accordance with some embodiments.

FIG. 10 depicts a flow chart diagram of one process for identifying customers using payment data.

### DETAILED DESCRIPTION

In the following description, numerous details are set forth for purpose of explanation. However, one of ordinary skill in the art will realize that the embodiments described herein may be practiced without the use of these specific details. In other instances, well-known structures and devices are shown in block diagram form to not obscure the description with unnecessary detail.

The systems and methods described herein include, among other things, computer systems that identify customers using payment and reservation data. The systems extract attributes such as customer names, menu items, and labor data from a merchant's POS system. In addition, the systems connect to third-party solution-providers such as OpenTable® to extract reservation information associated with customers who have established online identities.

In one implementation, the systems maintain one or more data processing servers and data warehouses with a secure cloud service, such as Amazon Web Services (AWS). Various attributes and data extracted from the merchant's POS system and the third-party solution-providers are then matched and analyzed on the secure cloud service.

To present the analytics to the merchants, a suitable web service (such as Amazon Web Services) and a mobile application may be implemented. This enables the conception of marketing strategies to promote specific menu items and of training plans to improve server performance.

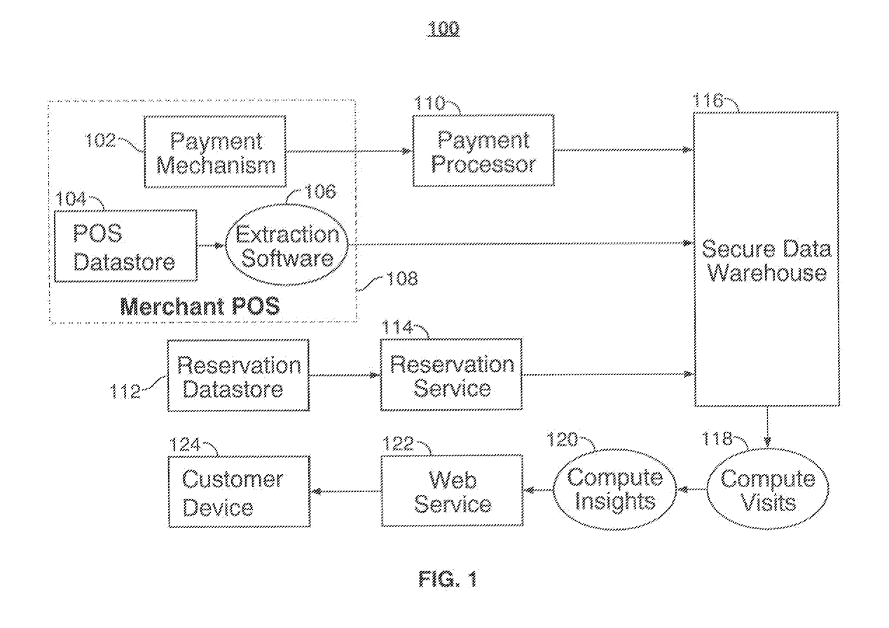

FIG. 1 depicts an exemplary system 100 that comprises a computer network system for supporting a system as described herein. System 100 includes a secure data warehouse 116, a plurality of data sources such as merchant POS 108 and reservation datastore 112, as well as a user interface implemented on customer device 124. In some embodiments, the merchant POS 108 may be implemented on the premises of a merchant's retail store. In some other embodiments, the merchant POS 108 may be a cloud-based service. Reservation datastore 112 may be housed by a third-party reservation service, such as OpenTable®, on an external data warehousing facility. Customer device 124 may be the merchant's electronic device, such as a smart phone or workstation.

The depicted merchant POS 108 may include a payment mechanism 102 and a data repository, such as POS datastore 104. The payment mechanism 102 may accept electronic means of payment such as credit cards or Apple Pay. The POS datastore 104 may store POS data such as order tickets (including basic card information used in the order, such as cardholder name and last four digits of the card number), ticket open and close times, menu items ordered, staff associated with the tickets, table numbers, reservations, and any other ticket information associated with the business transaction. In some embodiments, the ticket information may otherwise be known as check information. The POS datastore 104 may be locally implemented on the merchant POS 108. Alternatively, in the case of a cloud-based merchant POS system, the POS datastore 104 may be located remotely on a cloud server. The merchant accepts payments by integrating its payment mechanism 102 with a third-party payment processor 110, such as First Data®. In some implementations, the payment processor 110 may not be a third-party service, but instead is integrated into the merchant POS 108. Payment data may be sent by the merchant POS 108 to the payment processor 110 via proprietary protocols, and the protocols used may depend on the POS system in use. The parameters of the payment data may include for example: time, date, and amount of a transaction as well as credit card numbers. The payment processor 110 facilitates transactions and payments in a secure environment by connecting to credit card associations to authorize and settle payments. In some implementations, the payment processor 110 may also include functionalities such as fraud detection, customer loyalty programs, and mobile payments. After authorizing and settling a credit card transaction, the payment processor 110 generates credit card reports containing the payment data and makes the credit card reports available to the POS 108 via a secure protocol, such as SSH File Transfer Protocol (SFTP).

Extraction software, such as extraction software 106, may extract POS data from POS datastore 104 at particular intervals, such as once a day or any suitable time interval. In one implementation, the extraction software 106 may be locally installed on the merchant POS 108 to securely retrieve the POS data saved on the POS datastore 104 and transmit the POS data to a secure data storage, such as secure data warehouse 116. Alternatively, if the POS datastore 104 is implemented on the cloud, the POS datastore 104 may post the POS data to the secure data warehouse 116 by way of an application programming interface (API). Sensitive information such as credit card numbers are typically encrypted, hashed, and tokenized in order to ensure compliance with the PCI Data Security Standard (PCI DSS).

Notably, as a security measure, credit card numbers are not typically used directly in identifying customers. Instead, the credit card numbers polled from the credit card reports are hashed by a one-way hash function so that multiple transactions using the same credit card can be linked. In some implementations, the credit card number associated with a first transaction is hashed to a unique hash value. In a subsequent (second) transaction, the same credit card number is hashed again and the same hash value is obtained. By matching the two hash values, the first and second transactions will become linked. As an added measure of security, the one-way hash values are not communicated to or used in any other parts of the system once a link has been made across transactions. Instead, a generated token having a one-to-one relationship with the credit card number may be used as a secure reference. In some embodiments, the token may be generated randomly, by an application of a one-way hash function, truncation, or any other suitable tokenization mechanism. In some implementations, once multiple transactions are linked by the same one-way hash value, a corresponding randomly-generated token is looked up and associated with the transactions. In some implementations, the last four digits of the credit card number may also be associated with the transactions for verification purposes. By using a randomly-generated token rather than the one-way hash value, references to credit card numbers are securely protected against possible reverse hashing.

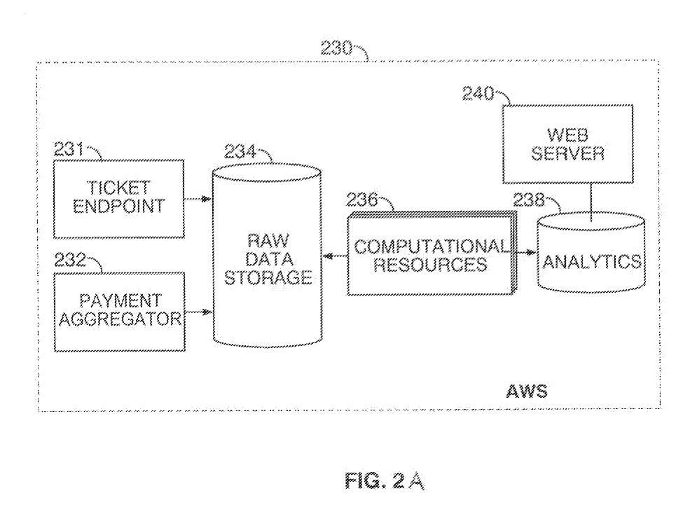

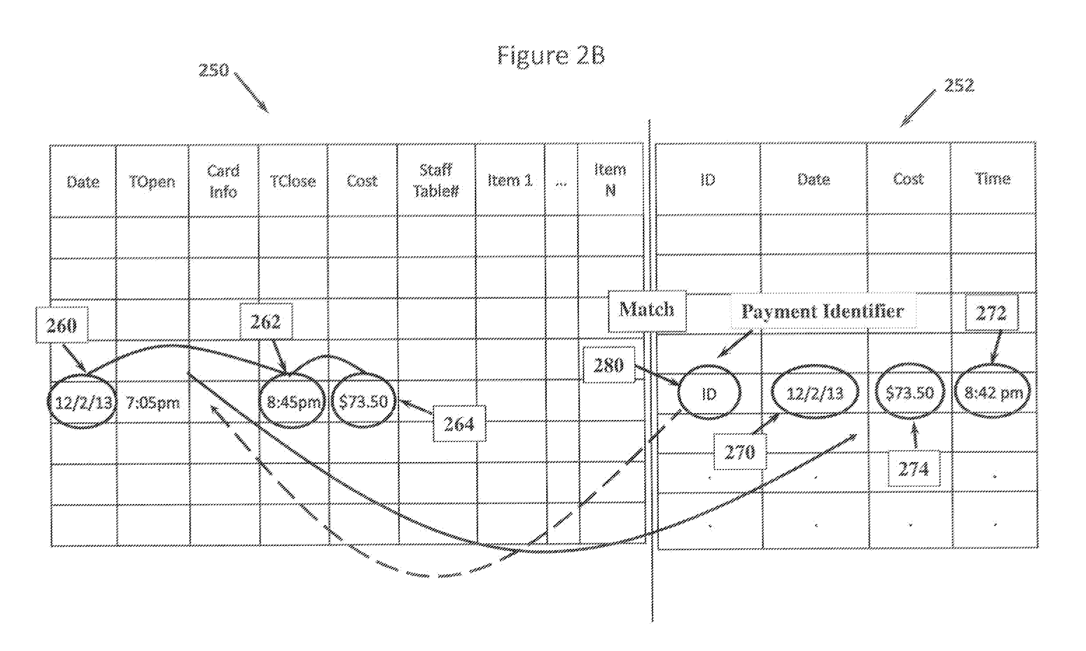

The secure data warehouse 116 may be a data processing environment that can be implemented on a secure cloud service, such as AWS. An exemplary secure cloud service 230 implemented using AWS is shown in FIG. 2A. In some implementations, the secure cloud service comprises a ticket endpoint 231, a payment aggregator 232, a raw data storage 234, which may include components such as Amazon Simple Storage Service (Amazon S3) or Amazon Relational Database Service (Amazon RDS), computational resources 236, and analytics 238. A webserver 240 is also provided in the depicted cloud service 230. Computational resources 236 may include Amazon Elastic Compute Cloud (Amazon EC2) and a big-data pipelining service such as AWS Data Pipeline employing Amazon Elastic MapReduce (Amazon EMR). Amazon EC2 provides and manages server instances to accommodate basic cloud-computing needs. External data, such as the payment data and the POS data described above, are stored as facts in Amazon RDS or Amazon S3. To coordinate the processing and transformation of data between different computing and storage services, the big-data pipelining service creates Amazon EMR clusters by rebuilding analytics documents from the facts according to a set of transformation definitions on a regular basis (e.g., nightly).

The credit card reports generated by the payment processor 110 may be available for download via an SFTP server. In some implementations, the payment aggregator 232 downloads the credit card reports from the SFTP server at regular intervals. From the credit card reports, relevant information such as payment data may be parsed and stored into a normalized data structure by Amazon EC2. Additional relevant data extracted by the extraction software 106 may be transmitted to the ticket endpoint 231 via Hypertext Transfer Protocol over Secure Socket Layer (HTTPS). As discussed above, sensitive information may be further encrypted prior to being transmitted to ensure PCI DSS compliance.

Auxiliary data sources, such as reservation datastore 112, may also be incorporated into system 100 by integrating with third-party solution-providers such as OpenTable®. A merchant may receive reservation data from reservation datastore 112 with reservation services 114 over SFTP in a number of formats, including Comma-Separated Values (CSV). Alternatively, the reservation data may be captured locally within the merchant's store environment, thereby bypassing the reservation services 114. For example, each time when a pre-shift reservation report from OpenTable® is printed at the merchant's store, the reservation data contained within the report may be captured by a printer firmware and saved locally. This allows the merchant to obtain and monitor its reservation data without having to interact with any third-part interface.

Once the various data is stored in the raw data storage 234 as described above, a suitable big-data algorithm, such as Map-Reduce, may be applied to aggregate the various data into a complete set representative of each customer visit. In one implementation, the big-data algorithm is carried out using Amazon EMR. For example, the big-data algorithm may match POS data, OpenTable® reservation data, and payment data during each customer visit by comparing various identifiers, such as timestamps, dollar amounts, partial credit card information (e.g., cardholder names and last four digits of credit cards), and table data. In some implementations, false detection or collision may occur during the matching process, and a number of supporting mechanisms are in place to resolve the matching conflicts. For instance, consumers may enroll credit card numbers and their names independently of the payment system, which can be used to resolve duplicates in the matching process. As another example, the system may identify suspected duplicate profiles for the same customer. This identification can be done by comparing POS parameters to correlate highly, such as more than one standard deviation, may be flagged and presented to the merchant to allow the merchant to visually inspect such matched profiles and consider combining the matched profiles into a single profile. This system may allow the merchant to manually de-duplicate customer profiles. Alternatively, cardholder names may be used to de-duplicate multiple card numbers associated with a single name.

FIG. 2B depicts pictorially one specific process for correlating data records stored in the POS datastore 104 with data records stored in the secure data warehouse 116. In certain particular embodiments, the datastore 104 and the secure warehouse 116 both include database systems. For example, the POS datastore 104 may include a SQL database system, including any commercially suitable database system. However, those of skill in the art will know that any suitable computer searchable system for storing related elements of data, including for example CSV files, may be used with the system and methods described herein.

For the embodiment depicted in FIG. 2B, the data stored by the POS system 108 and the payment system, whether it is a credit card company, Apple® Pay, PayPal®, or some other electronic payment system, are stored in relational database systems, 250 and 252.

As described above, the database systems 250 and 252 are typically two separate systems. The POS system 108 stores table 250 that contains the POS data. The POS data includes the data that can be captured by the POS system. The POS system is usually an electronic sales system that collects data about the transaction, and the collected data provide parameters that describe the transaction. As shown in FIG. 2B, these parameters can include a date parameter, a TOpen parameter recording the time the ticket was opened, a TClose parameter the time the ticket was closed, typically by paying the bill, the amount of the invoice, the items purchased during that transaction, the staff, the table and other parameters.

The POS systems 108 may include a credit card payment system 102 that allows the merchant to have the credit card account number read into the POS system 108, typically by using system 102 that has a magnetic stripe on the credit card. The credit card data is transmitted, as described above, to a payment possessor 110 that can make the payment and record the debit owed by the entity associated with the processed credit card number. The data associated with the debit owed can be recorded by the credit card company as parameters in the secure table 252. These parameters can include the identity of the entity associated with the account, such as the name and the address, the date of the transaction, the cost of the transaction, the time of the transaction and any other data captured as part of processing the payment.

In FIG. 2B, the tables 250 and 252 represent two separate databases, each containing thousands of machine readable records. The data tables 250 and 252 are typically created separately and through processes that do not include a link between a data record of a transaction in the POS datastore 104 with data record of a transaction in the payment transaction datastore maintained in secure data warehouse 116. The systems and methods described herein can, in some embodiments, create a link to related transactions by matching parameters stored in a data record of POS datastore 104 with parameters stored in the payment transaction data records maintained in secure data warehouse 116.

In the embodiment depicted in FIG. 2B, the system 100 employs a matching process that identifies parameters captured by POS system 108 that are related to the debt of the credit transaction undertaken by the credit card company and therefore are parameters that will be captured by the payment processor 110. For example, in FIG. 2B, the system 100 creates match criteria by extracting the date parameter 260, TClose parameter 262 and cost parameter 264. The POS ID 290 can be associated by the system 100 with the match criteria. The extraction software 106 can transmit the match criteria to the secure data warehouse 116. The secure data warehouse 116 can identify the data table associated with the merchant that sent the match criteria. The secure data warehouse 116 can compare the match criteria to each data table that is associated with that merchant. In the process shown in FIG. 2B, the secure data warehouse 116 finds one record that has data fields that match with the transmitted match criteria. The secure data warehouse 116 can then identify the parameter ID 280 associated with that transaction and use that parameter ID 280 to provide the merchant with a payment identifier that represents the entity associated with that payment mechanism, such as a four digit number that identifies the entity that holds the credit card accounts. This allows the transaction in the POS datastore 14 to be linked to the ID parameter, or a proxy for that ID parameter, stored in the data table 252. This ID parameter can be entered as a field 290 in the data table 250. Subsequent data analysis can now collect transactions in the POS datastore that have the same value in this field 290. This allows for the generation of customer metrics.

After the matching-conflict resolution process, a number of supporting algorithms may be implemented to analyze the matched data clusters for each customer visit. For instance, Amazon EMR may compute multiple customer visits by using an elastic Map/Reduce cluster and a redshift service. In general, the matched data set for each customer visit may be used to compute consumer metrics (i.e., compute visits 118) such as retention, menu item price, cost, profit, server name, item popularity, major/minor item category, number of covers at a table, sales per cover, tip percentage, table-turn time, or server shift times. Lastly, the computed consumer metrics may be grouped by a particular dimension, such as a menu item, a server, or a time of day, in order to identify business insights (i.e., compute insights 120).

The merchant may access the identified business insights through any web client, such as customer device 124. The presentation of business insights may be powered by web service 122 running Ruby on Rails or a similar proprietary platform. In some implementations, the web service 122 is run by web server 240 of FIG. 2A. The presentation of web pages on the customer device 124 may be rendered in HTML5, JavaScript, or any other suitable client-side language. These business insights may include analytics pertaining to customer behavior over time, business profitability, retentive power, popularity of menu items, and customer preferences.

For example, the retentive power of a restaurant menu item such as “Fish Tacos” may be computed. In one such analysis, the system stores credit card Primary Account Numbers (PANs) as the payment identifier parameter. The system can identify ticket information that represents the purchase of Fish Tacos. The process can then analyze retentive power, in one practice, by mathematically comparing the number of distinct PANs that returned for Fish Tacos with the overall number of PANS that show the purchase of Fish Tacos as follows:

$$Retentive Power ( Fish Tacos ) = \frac{\begin{matrix}\# of distinct PANs that have returned for \\ more purchases after ordering Fish Tacos\end{matrix}}{\# of distinct PANs that ordered Fish Tacos}$$

Such analytics enables the merchant/retailer to conceive marketing strategies to promote specific menu items, and of training plans to improve staff performance. As an example, products having a high retention power and low sales volume may deserve more marketing attention because their uninspiring performance is very likely due to a lack of publicity.

The above-described system architecture offers a number of benefits that were previously unavailable to merchants. For example, the systems and methods described herein allow a merchant to determine whether a particular customer, as identified by their credit card number, ever returned to the merchant, or whether customers who order a certain dish are more likely to return than others. In general, the merchant may identify any factors that impacted a customer's experience, and infer the impact that experience had on the customer, as judged by their likelihood of returning. Furthermore, the systems and methods described herein allow the merchant to interact with a customer in real time. For example, a merchant can recall a customer's identity and profile information whenever she makes a payment or signs in for a reservation. This allows the merchant's staff to greet and interact with the customer in a more powerful way, by automatically recalling the customer's history, personal information, and preferences.

It will be apparent to one of ordinary skill in the art, that although FIG. 1 depicts one secure data warehouse 116, a plurality of data warehouses or cloud servers can be used simultaneously. Similarly, a number of merchant POS systems in addition to the merchant POS 108, as well as additional web clients may be incorporated in the system 100 without deviating from the scope of the present disclosure. The system 100 may be realized as software components operating on conventional data processing systems, such as a Unix or Linux workstation. In that embodiment, the system 100 can be implemented as a C language computer program, or a computer program written in any high level language including C++, Fortran, Java, or Python. Additional languages may be used to implement other features of the user interface, such as Ruby on Rails, PHP, JavaScript, and HTML/HTML5. General techniques for programming in these languages are known in the art and set forth in, for example, Wes McKinney, Python for Data Analysis: Data Wrangling with Pandas, NumPy, and IPython, O'Reilly Media (2012).

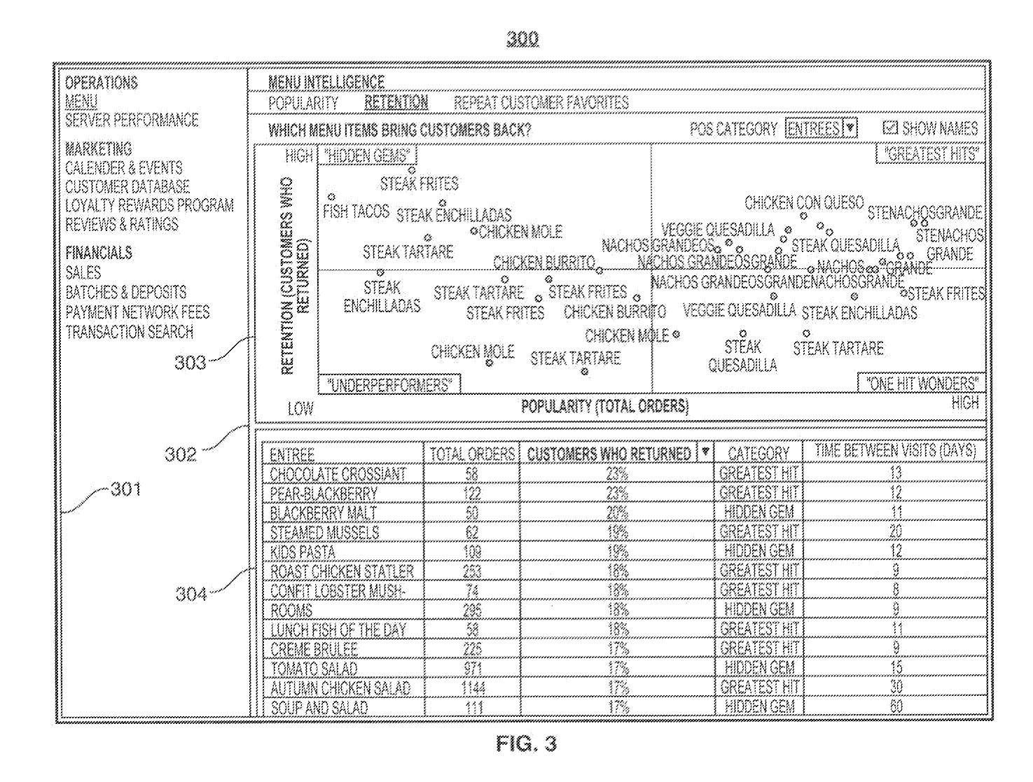

FIGS. 3-9 illustrate various reports that a merchant/retailer user may access using the systems and methods described herein. In some implementations, FIGS. 3-9 may be generated by the web service 122 and displayed on the customer device 124, which, for example, may be the merchant's personal computer or mobile devices. FIG. 3 depicts an exemplary web page 300 illustrating retention insights for a restaurant derived from data collected using system 100. The merchant may click on any headings in area 301 to navigate to a corresponding page. For instance, by clicking on the heading “MENU”, the merchant is presented with area 302, which comprises plot 303 and table 304. It is understood that other plots, tables, diagrams, charts, or any suitable presentation format may be used to present information in area 302 if a user selects a different heading in area 301.

Plot 303 is an exemplary plot of Retention (customers who returned) vs Popularity (total orders), in which each plotted data point represents a menu item. The plot area of plot 303 is divided into four quadrants that can be used to categorize and label menu items (e.g., “Hidden Gems”, “Underperformers”, “Greatest Hits”, or “One Hit Wonders”). As discussed above in relation to FIG. 1, such categorization may be based on analytics pertaining to customer behavior over time, business profitability, retentive power, popularity of menu items, and customer preferences. The categorized menu items presented in plot 303 allows a merchant/retailer to visualize performance metrics of each individual menu item.

Table 304 presents the additional information associated with the menu items illustrated in plot 303. In table 204, each menu item is listed against its corresponding Total Orders, Customer Retention Rate, Category, or Time between Visits (days). Together, plot 303 and table 304 allow the merchant/retailer to conceive targeted strategies to promote specific menu items.

In an implementation, the merchant/retailer may select an appropriate menu item class, such as Entrees, by which to filter their menu items. Each menu item's popularity is computed by counting the number of orders that appear on POS ticket records over a preset time period, and retention is determined by computing the percentage of customers who have returned to the restaurant, as identified by their credit card number, after ordering a particular menu item. In table 204, all menu items are categorized according to percentiles for popularity and retentions. The categories may then be used to deduce business insights: items with high retention and high popularity are greatest hits that support the business; items with low retention and low popularity are underperformers that may be removed from the menu; items with high retention and low popularity are hidden gems, the sales of which may be significantly improved with targeted marketing and promotion efforts; and items with low retention and high popularity are one-hit wonders that deserve further investigation—perhaps the item should be cut from the menu, or perhaps the item should be improved to make a better impression on customers.

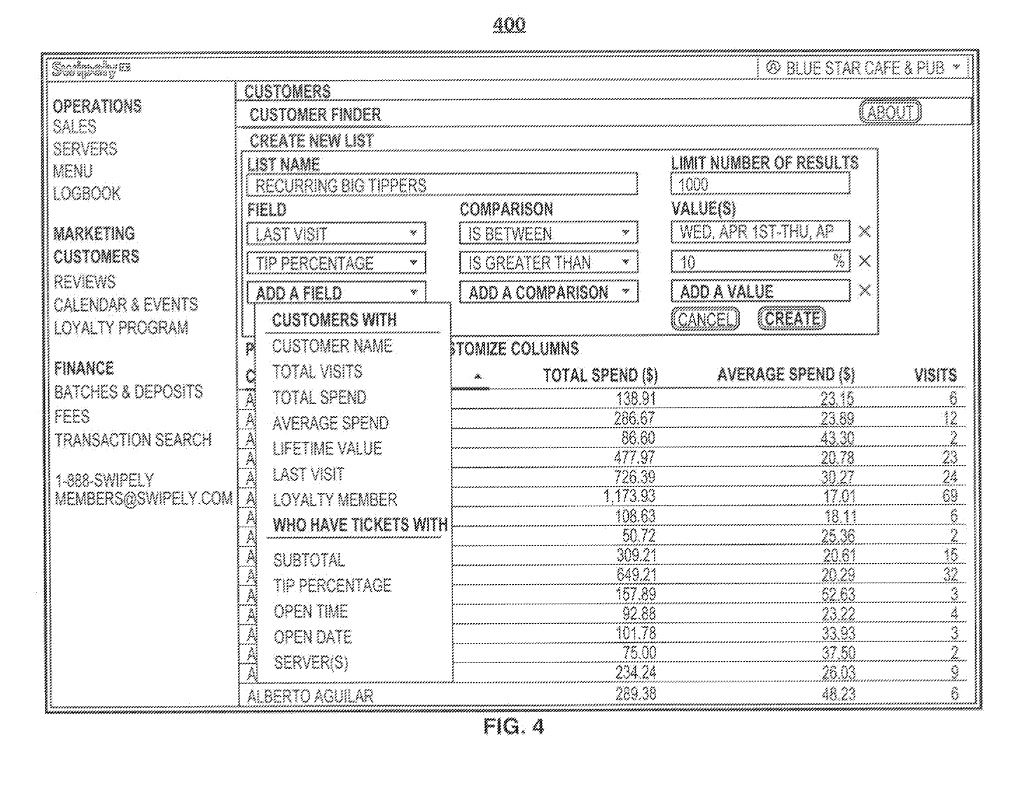

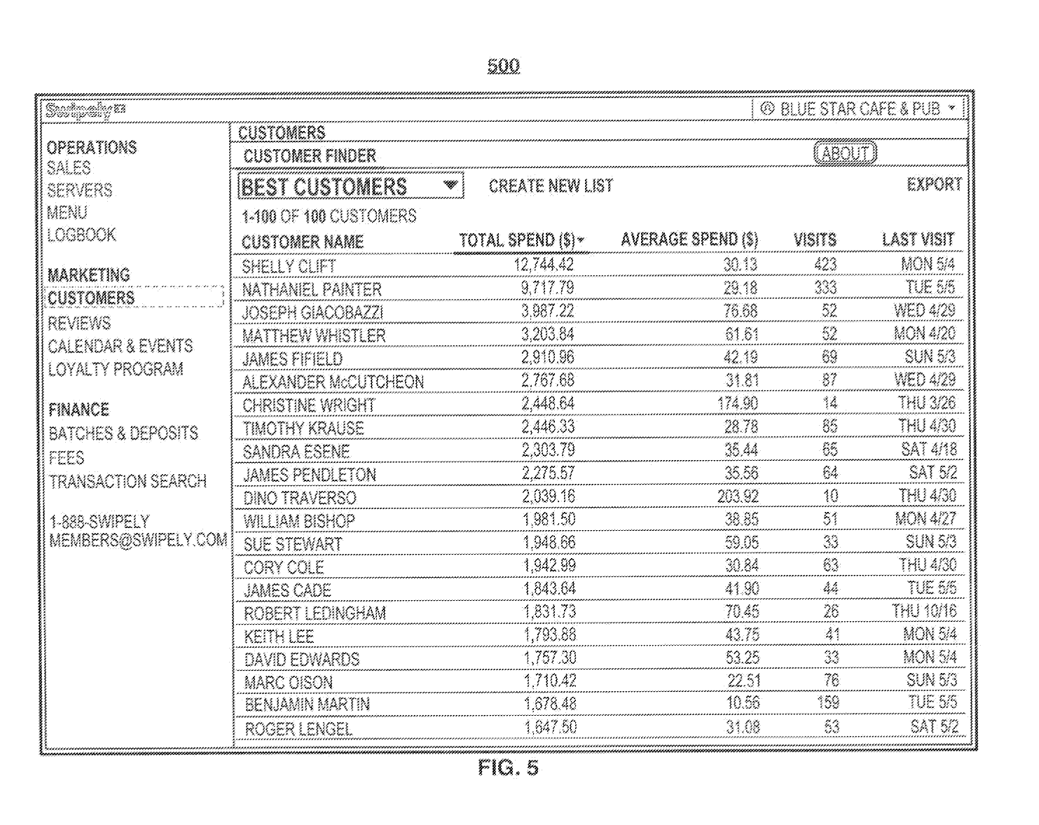

FIG. 4 is an exemplary web page 400 of creating a new customer list as accessible on user devices in accordance with some embodiments. The merchant/retailer may customize a list of customers based on a number of sorting criteria as illustrated. For example, the merchant/retailer may use the systems and methods described herein the compile a list of “recurring big tippers” based on the date of the last visit and the tip percentage. As another example, the merchant/retailer may create a list of “best customers”, as illustrated in FIG. 5, based on a different set of criteria. In FIG. 5, the web report 500 of “best customers” shows the highest spending customers across multiple visits for the business.

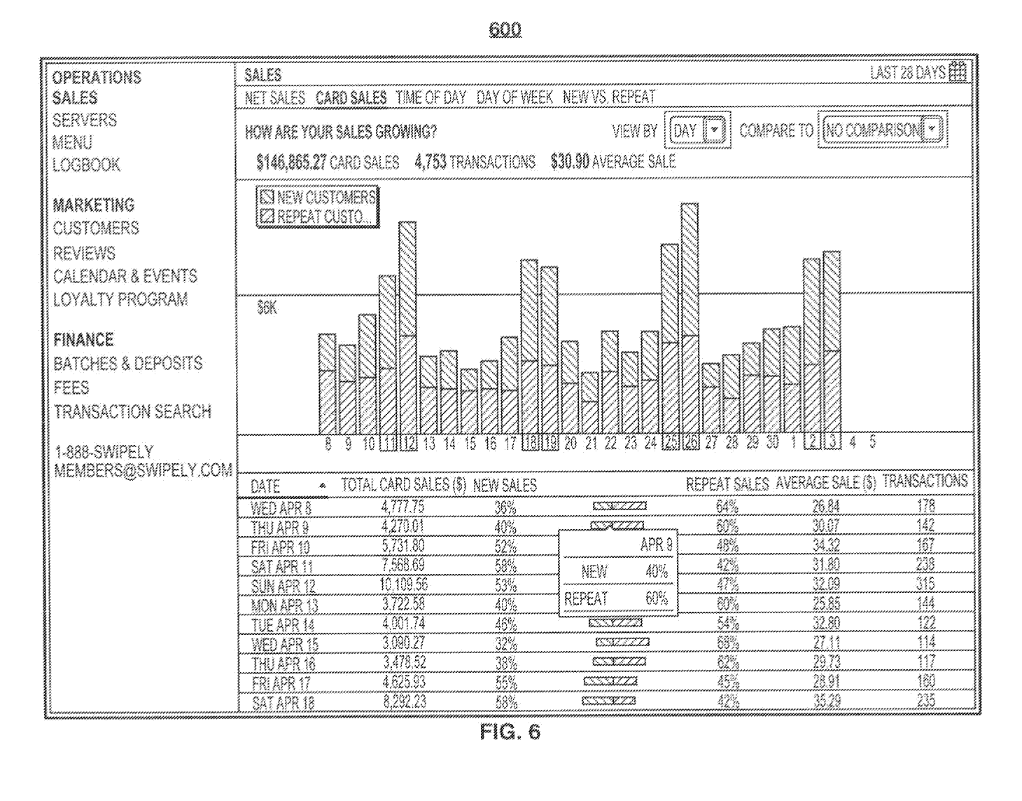

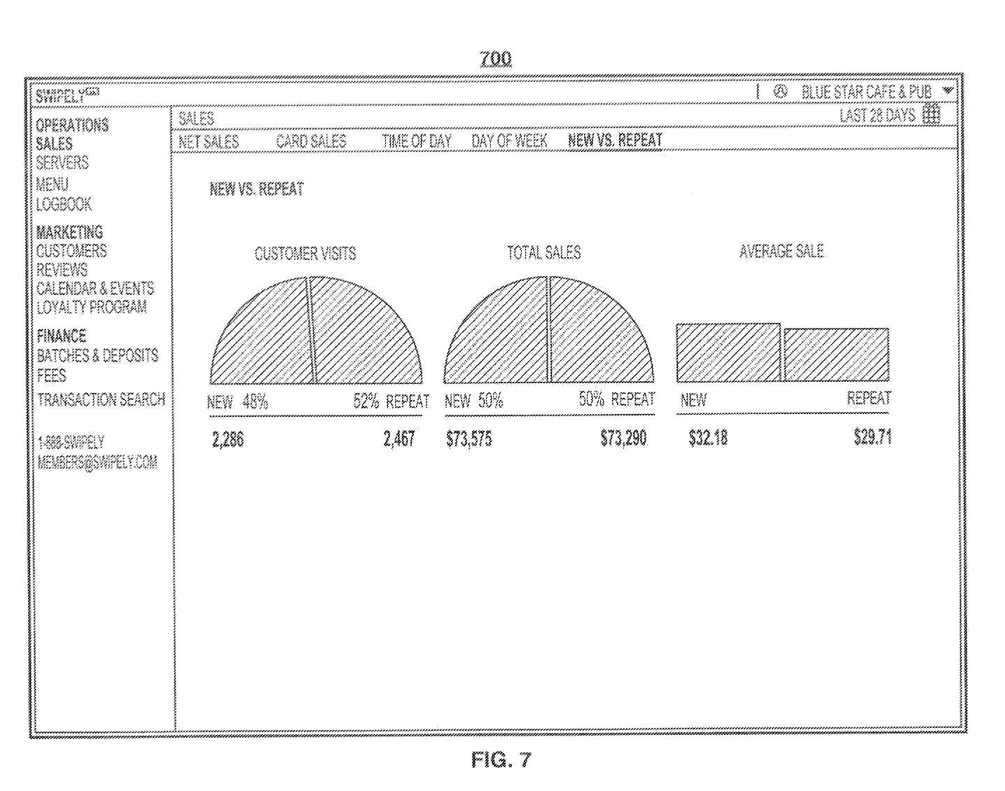

FIG. 6 is an exemplary web report 600 of sales data as displayed on user devices in accordance with some embodiments. On the web report 600, the merchant/retailer is able to visualize sales performance over time across multiple metrics, such as percentage of repeat sales, average sale dollar amount, and number of transactions. The percentage of repeat sales is a metric that illustrates sales revenue generated by new customers compared against sales revenue generated by returning customers. A detailed breakdown of different types of new vs. repeat sales data is shown in illustrative web report 700 of FIG. 7. In the web report 700, new vs. repeat data is further sliced by customer visits, total sales, and average sale per transaction.

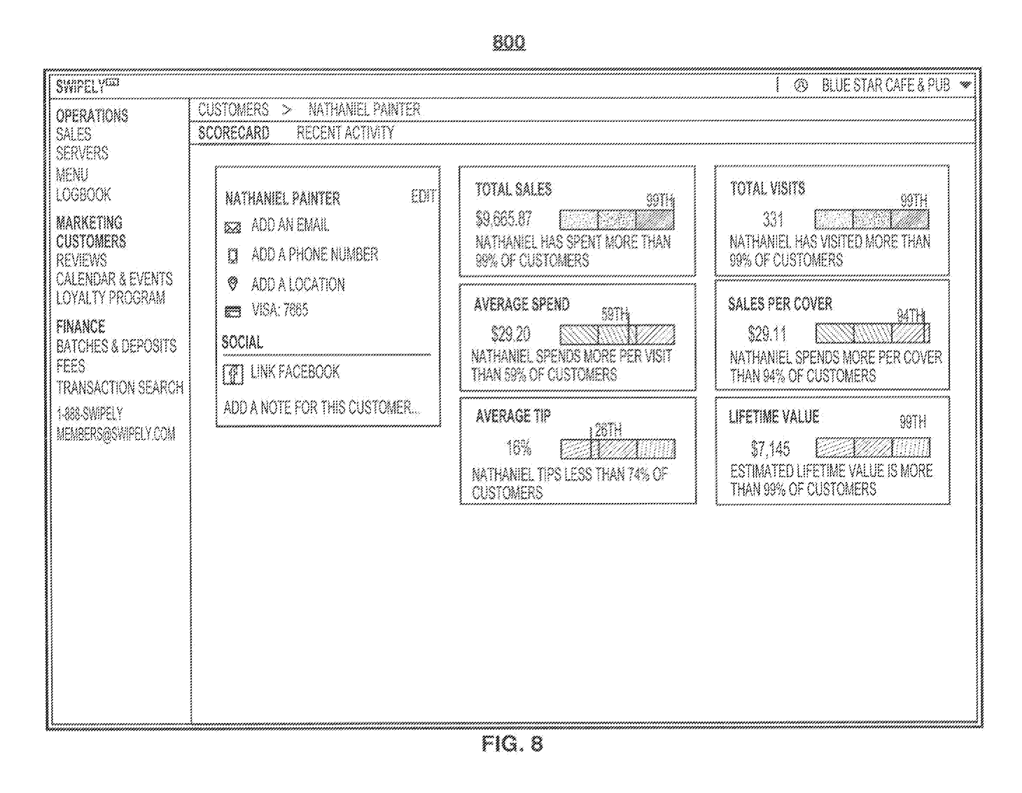

FIG. 8 is an exemplary web report 800 of customer relationship management (CRM) scorecard as displayed on user devices in accordance with some embodiments. The information displayed on the web report 800, on a customer named Nathaniel Painter, is collected and generated using the systems and methods described herein, as will become apparent in view of the following example.

POS data (including order tickets) and payment data are separately received by ticket endpoint 231 and payment aggregator 232, respectively. Once the POS data and the payment data are securely stored, computational resources 236 performs elastic map/reduce algorithm to generate data clusters representative of each individual visit by Nathaniel Painter In one implementation, the elastic map/reduce algorithm first maps POS data and payment data using a (store, day) key, and then reduces the matched data by comparing date, time, amount of transaction, and the last four digits of the credit card number used in the transaction to assign the reduced data set to a customer ID. As a result, data clusters representative of individual visits by Nathaniel Painter (associated with the customer ID) is saved in raw data storage 234. Two additional computations may be performed on the customer data clusters to arrive at the CRM information displayed in the web report 800. First, an additional elastic map/reduce algorithm may be implemented to compute distributions for merchant stores across multiple customers. This additional elastic map/reduce algorithm establishes store-level benchmarks for the merchant/retailer. Second, a redshift service can be employed to compute customer analytics. In an implementation, the redshift service counts the total number of visits over a time frame, sums the total sales, total covers, and tip over the same time frame, and calculates the maximum and minimum visit times for the first and the latest visit for Nathaniel Painter. Both the store-level benchmarks and the customer analytics are then sent to the web server 240 to be arranged in a web report format. As a result, the customer scorecard as shown in the web report 800 is available for display, which illustrates the total sales, dollar amount of average purchases, total visits, and other CRM data associated with Nathaniel Painter.

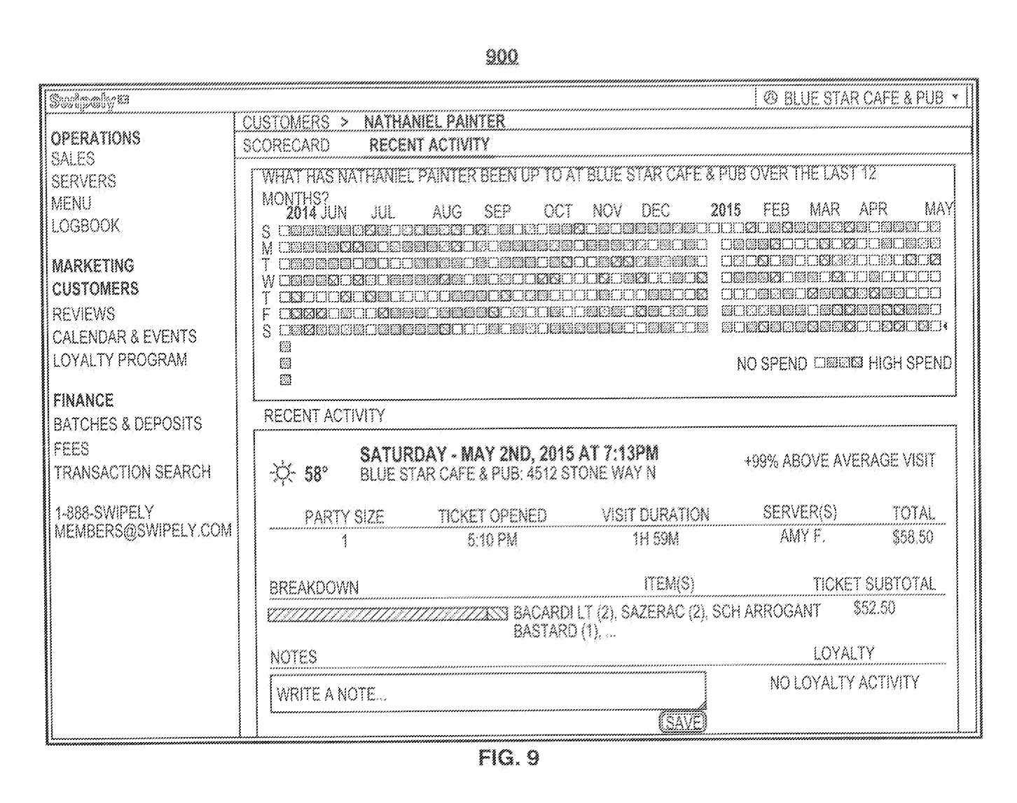

FIG. 9 is an exemplary web report 900 of recent customer activity as displayed on user devices in accordance with some embodiments. The web report 900 presents additional information on the recent activities of the customer in FIG. 8. For example, the web report 900 presents a visual map illustrating the question “What has Nathaniel Painter been up to at Blue Star Cafe & Pub over the last 12 months?” Patterns of high spending over different days of the week and different months of the year can be observed, and potential marketing insights be gained with respect to the customer.

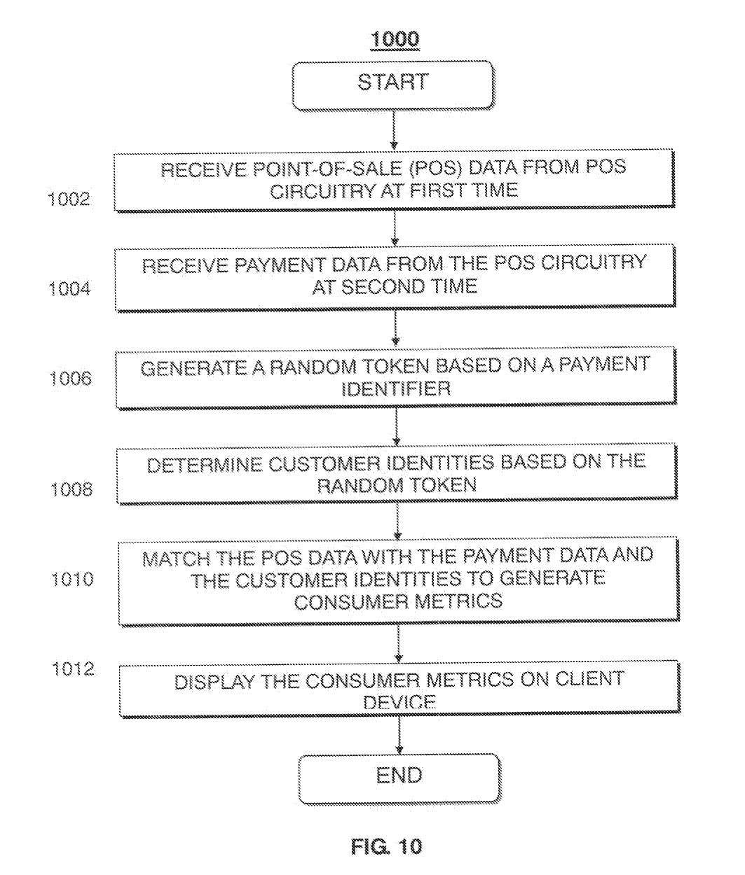

FIG. 10 depicts a flow chart diagram of process 1000 for identifying customers using payment data. After the process 1000 starts, at 1002, a customer-identifying system runs extraction software on POS circuitry to encrypt POS data. The POS data is then received, at a first time, at a cloud-based server from the POS circuitry. In an implementation, the customer-identifying system is the system 100 of FIG. 1 and the POS circuitry is the merchant POS 108. As previously discussed, the encrypted POS data may contain sensitive information such as credit card names or credit card numbers. At 1004, a processor, such as the payment processor 110, receives payment data from the POS circuitry at a second time. As discussed above in relation to FIG. 1, the payment data may be received in the form of credit card reports. Additional data may be received from third-party sources such as online reservation platforms. The encrypted POS data, the payment data, and any additional data from third-party sources may be transmitted to a secure server via a standard or proprietary communication protocol. At 1006, the secure server, such as the secure data warehouse 116, generates a random token based on a payment identifier, such as the credit card number information in the payment data. The random token may be used to determine customer identities at 1008. At 1010, the secure server matches the encrypted POS data with the payment data, the customer identities, and any additional data to generate consumer metrics. In some embodiments, the matched data sets are used to first generate intermediate data clusters, which are then used to calculate consumer metrics. Data pipelining techniques such as Amazon EMR may be used to generate and maintain the data clusters and consumer metrics.

At 1012, a merchant/retailer can review reports on various consumer metrics displayed on a client device, such as those shown in FIGS. 3-9.

Some embodiments of the above described may be conveniently implemented using a conventional general purpose or a specialized digital computer or microprocessor programmed according to the teachings herein, as will be apparent to those skilled in the computer art. Appropriate software coding may be prepared by programmers based on the teachings herein, as will be apparent to those skilled in the software art. Some embodiments may also be implemented by the preparation of application-specific integrated circuits or by interconnecting an appropriate network of conventional component circuits, as will be readily apparent to those skilled in the art.

Some embodiments include a computer program product comprising a computer readable medium (media) having instructions stored thereon/in and, when executed (e.g., by a processor), perform methods, techniques, or embodiments described herein, the computer readable medium comprising sets of instructions for performing various steps of the methods, techniques, or embodiments described herein. The computer readable medium may comprise a storage medium having instructions stored thereon/in which may be used to control, or cause, a computer to perform any of the processes of an embodiment. The storage medium may include, without limitation, any type of disk, flash memory devices, or any other type of media or device suitable for storing instructions and/or data thereon/in.

Stored on any one of the computer readable medium (media), some embodiments include software instructions for controlling both the hardware of the general purpose or specialized computer or microprocessor, and for enabling the computer or microprocessor to interact with a human user and/or other mechanism using the results of an embodiment. Such software may include without limitation device drivers, operating systems, and user applications. Ultimately, such computer readable media further includes software instructions for performing embodiments described herein. Included in the programming (software) of the general-purpose/specialized computer or microprocessor are software modules for implementing some embodiments.

Suitable operating systems, databases or servers may be integral to the cloud system on which, for example, secure data warehouse 116 is implemented. The operating systems, databases and servers can be any suitable systems, including commercially available solutions or customized solutions. In addition, these systems may be supported by any suitable persistent data memory, such as a hard disk drive, RAID systems, or any other suitable hardware options. The design and development of suitable operating systems, databases, and servers are known and understood by those of ordinary skill in the art.

Those of skill would further appreciate that the various illustrative logical blocks, modules, techniques, or method steps of embodiments described herein may be implemented as electronic hardware, computer software, or combinations of both. To illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the embodiments described herein.

The various illustrative logical blocks, modules, and circuits described in connection with the embodiments disclosed herein may be implemented or performed with a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein.

The techniques or steps of a method described in connection with the embodiments disclosed herein may be embodied directly in hardware, in software executed by a processor, or in a combination of the two.

Accordingly, it will be understood that the invention is not to be limited to the embodiments disclosed herein, but is to be understood from the following claims, which are to be interpreted as broadly as allowed under the law.

1. A method for identifying customers using payment data, comprising
receiving point-of-sale (POS) data from POS circuitry, wherein the POS data includes parameters of a transaction and ticket information representative of items purchased during the transaction;
receiving payment data from a payment transaction system, wherein the payment data includes parameters of the transaction and a payment identifier;
matching, on the secure server, the parameters of the POS data with the parameters of the payment data and associating the payment identifier with the matched POS data; and
generating consumer metrics associated with the identified customer based on the ticket information, and the matched payment identifier data.

2. A method according to claim 1, wherein the payment identifier represents a parameter that associates two or more transactions with one payment mechanism.

3. A method according to claim 1, further comprising displaying the consumer metrics on a client device.

4. A method according to claim 1, wherein the POS data is received from the POS circuitry using extraction software running on the POS circuitry, and wherein the payment transaction system is the POS circuitry.

5. A method according to claim 1, further comprising generating a token based on the payment identifier, wherein the token has a one-to-one relationship with the payment identifier.

6. A method according to claim 1, further comprising:
receiving, at the secure server, reservation data from a reservation service; and
matching the reservation data with the POS data, the payment data, and the customer identities to generate the consumer metrics.

7. A method according to claim 1, wherein the POS data includes at least one of ticket number, cardholder name, credit card number, transaction time, menu item ordered, ticket open and close times, staff identification, and reservation information.

8. A method according to claim 1, wherein the consumer metrics associated with the identified customers is at least one of retention, menu item price, cost, profit, server name, item popularity, major/minor item category, number of covers at a table, sales per cover, tip percentage, table-turn time, and server shift times.

9. A non-transitory computer-readable medium storing a plurality of instructions for identifying customers using payment data, the plurality of instructions comprising:
an instruction to receive point-of-sale (POS) data from POS circuitry, wherein the POS data includes ticket information;
an instruction to receive payment data from a payment transaction system, wherein the payment data includes a payment identifier;
an instruction to identify a customer based on the payment identifier;
an instruction to match the POS data with the payment data; and
an instruction to generate consumer metrics associated with the identified customer based on the ticket information and the payment data.

10. A non-transitory computer-readable medium according to claim 9, wherein the plurality of instructions further comprising an instruction to display the consumer metrics on a client device.

11. A non-transitory computer-readable medium according to claim 9, wherein the plurality of instructions further comprising an instruction to generate a token based on the payment identifier, wherein the token has a one-on-one relationship with the payment identifier.

12. A non-transitory computer-readable medium according to claim 9, wherein the instruction to receive POS data from the POS circuitry comprises an instruction to receive the POS data using extraction software running on the POS circuitry, and wherein the payment transaction system is the POS circuitry.

13. A non-transitory computer-readable medium according to claim 9, wherein the plurality of instructions further comprising:
an instruction to receive reservation data from a reservation service; and
an instruction to match the reservation data with the POS data, the payment data, and the customer identities to generate the consumer metrics.

14. A non-transitory computer-readable medium according to claim 9, wherein the POS data includes at least one of cardholder name, credit card number, transaction time, menu item ordered, ticket open and close times, staff identification, and reservation information.

15. A non-transitory computer-readable medium according to claim 9, wherein the consumer metrics associated with the identified customers is at least one of retention, menu item price, cost, profit, server name, item popularity, major/minor item category, number of covers at a table, sales per cover, tip percentage, table-turn time, and server shift times.

16. A system for identifying customers using payment data, comprising
point-of-sale (POS) circuitry configured to process POS data, wherein the POS data includes ticket information;
a payment processor configured to receive payment data from a payment transaction system, wherein the payment data includes a payment identifier;
a secure server configured to:
receive the processed POS data and the payment data;
identify a customer based on the payment identifier,
match the processed POS data with the payment data, and
generate consumer metrics associated with the identified customer based on the ticket information and the payment data; and
a client device configured to display the consumer metrics associated with the identified customers.

17. A system according to claim 16, wherein the processed POS data includes at least one of cardholder name, credit card number, transaction time, menu item ordered, ticket open and close times, staff identification, and reservation information.

18. A system according to claim 16, wherein the payment transaction system is the POS circuitry.

19. A system according to claim 16, wherein secure server is configured to:
receive the processed POS data using extraction software running on the POS circuitry; and
generate a token based on the payment identifier, wherein the token has a one-on-one relationship with the payment identifier.

20. A system according to claim 16, wherein the consumer metrics associated with the identified customers is at least one of retention, menu item price, cost, profit, server name, item popularity, major/minor item category, number of covers at a table, sales per cover, tip percentage, table-turn time, and server shift times.

21. A system according to claim 16, wherein the secure server is further configured to:
receive reservation data from a reservation service; and
match the reservation data with the POS data, the payment data, and the customer identities to generate the consumer metrics.
